(19) United States
(12) Patent Application Publication
(10) Pub. No.: US 2017/0042199 A1
(43) Pub. Date: Feb. 16, 2017

(54) SYSTEM AND METHOD FOR PROCESSING LIQUID OR SEMI-LIQUID FOOD PRODUCTS WITH PARTICLES

(71) Applicant: TETRA LAVAL HOLDINGS & FINANCE S.A., Pully (CH)

(72) Inventor: Göran STJERNBERG, Lund (SE)

(73) Assignee: TETRA LAVAL HOLDINGS & FINANCE S.A., Pully (CH)

(21) Appl. No.: 15/305,528

(22) PCT Filed: Apr. 15, 2015
(86) PCT No.: PCT/EP2015/058139

§ 371 Date: Oct. 20, 2016

(30) Foreign Application Priority Data
Apr. 22, 2014 (SE) 1450475-7

(51) Int. Cl. A23L 2/46; A23L 2/02

(52) U.S. Cl. CPC A23L 2/46; A23L 2/02; A23V 2002/00

(57) ABSTRACT

It is provided a processing system for processing a liquid or semi-liquid food product. The food product is a composition of a first sub-composition having a low concentration of particles and a second sub-composition having a high concentration of particles. The high concentration is greater than said low concentration. The processing system comprises a first mixing tank for mixing said first sub-composition, a second mixing tank for mixing said second sub-composition, and a heat treatment apparatus arranged to receive said first sub-composition and said second sub-composition and to heat treat said first sub-composition and said second sub-composition.

### TECHNICAL FIELD

The invention generally relates to the field of liquid food processing. More particularly, it is presented a system and a method for processing a liquid or semi-liquid food product with particles, such as orange juice with pulp.

### BACKGROUND OF THE INVENTION

Today, there is an increasing interest from customers for liquid food products containing particles, such as juice containing pulp. Since processing liquid food products with particles is more complex than processing liquid food products without particles, food processing companies from time to time find themselves in a situation where they need to choose between a system handling the food product and the particles together, which implies a number of constraints, or a more expensive system that handles the particles and the food product separately and then combine them into a final product.

More in detail, the available systems can be divided in two main concepts, herein referred to as an aseptic single line design and an aseptic dual line design. In the aseptic single line design, taking juice and pulp particles as example, the juice and the pulp particles are mixed, heat treated, stored and filled in packages. In the aseptic dual line design, the juice and pulp particles are separately mixed, heat treated, stored and then combined before being transferred to the filling step.

A drawback with the aseptic single line design is that there is a limitation in particle size, since the particles are processed together with the juice. A further drawback, and an effect of having juice and pulp particles mixed from the start, is that deaeration and homogenization cannot be made without negatively affecting the product and the particles. Still a drawback is that by combining the juice and pulp particles from the start, the holding time will increase, that is, extra time is needed in order to make sure that unwanted microorganisms in the product is reduced below a set level such that the product placed in an appropriate package can be safe to consume until an expected due date. For the dual line design, the drawback is primarily that additional equipment is needed with increased capital expenditures as a result.

### SUMMARY

Accordingly, the present invention preferably seeks to mitigate, alleviate or eliminate one or more of the above-identified deficiencies in the art and disadvantages singly or in any combination and solves at least the above mentioned problems.

According to a first aspect it is provided a processing system for processing a liquid or semi-liquid food product, said food product being a composition of a first sub-composition having a low concentration of particles and a second sub-composition having a high concentration of particles, wherein said high concentration is greater than said low concentration, said processing system comprising a first mixing tank for mixing said first sub-composition, a second mixing tank for mixing said second sub-composition, a heat treatment apparatus arranged to receive said first sub-composition and said second sub-composition and to heat treat said first sub-composition and said second sub-composition.

The heat treatment apparatus may be divided in a plurality of sections, wherein a first set of said plurality of sections is arranged to pre-heat said first sub-composition to a pre-heat treatment temperature and a second set of said plurality of sections is arranged to heat treat said first sub-composition and said second sub-composition at a heat treatment temperature, wherein said pre-heat treatment temperature is lower than said heat treatment temperature.

The processing system may further comprise a deaerator arranged to deaerate said first sub-composition.

The first sub-composition may be pre-heated in said heat treatment apparatus before being transferred to said deaerator.

The processing system may further comprise a homogenizer arranged to homogenize said first sub-composition.

The first sub-composition may be pre-heated in said heat treatment apparatus before being transferred to said homogenizer.

The processing system may further comprise an aseptic storage tank arranged to receive said first sub-composition and said second sub-composition from said heat treatment apparatus.

The aseptic storage tank may be provided with paddle agitators.

The second sub-composition may comprise water and particles slurry with a ratio of approximately 1:1.

The first sub-composition and said second sub-composition may be combined with a ratio of approximately 5:1.

The first sub-composition may comprise 80-95 per cent of water.

The first sub-composition may comprise 6-18 per cent of sugar.

The second sub-composition may comprise particles with a size in a range of 1-10 mm.

According to a second aspect it is provided a method for processing a liquid or semi-liquid food product, said food product being a composition of a first sub-composition having a low concentration of particles and a second sub-composition having a high concentration of particles, wherein said high concentration is greater than said low concentration, said method comprising mixing said first sub-composition in a first mixing tank, mixing said second sub-composition in a second mixing tank, heat treating said first sub-composition and said second sub-composition in a heat treatment apparatus arranged to receive said first sub-composition and said second sub-composition such that a final product is formed.

The method may further comprise pre-heating said first composition to a pre-heat treatment temperature in a first set of a plurality of sections of said heat treatment apparatus, wherein said step of heat treating said first sub-composition and said second sub-composition is made in a second set of said plurality of sections at a heat treatment temperature, wherein said pre-heat treatment temperature is lower than said heat treatment temperature.

The method may further comprise transferring said final product to a filling machine at ambient temperature.

According to a third aspect it is provided a liquid food product obtained by the method according to the second aspect.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, wherein:

FIG. 1 illustrates an aseptic single line design for processing juice comprising pulp particles.

FIG. 2 illustrates an aseptic dual line design for processing juice comprising pulp particles.

FIG. 3 illustrates an aseptic line design with separate mixing tanks for juice and pulp particles.

FIGS. 4a and 4b are flow charts illustrating the aseptic line design illustrated in FIG. 3.

### DETAILED DESCRIPTION OF PREFERRED EMBODIMENTS

Today there are two different general line concepts for processing liquid food products with particles, herein referred to as an aseptic single line and as an aseptic dual line.

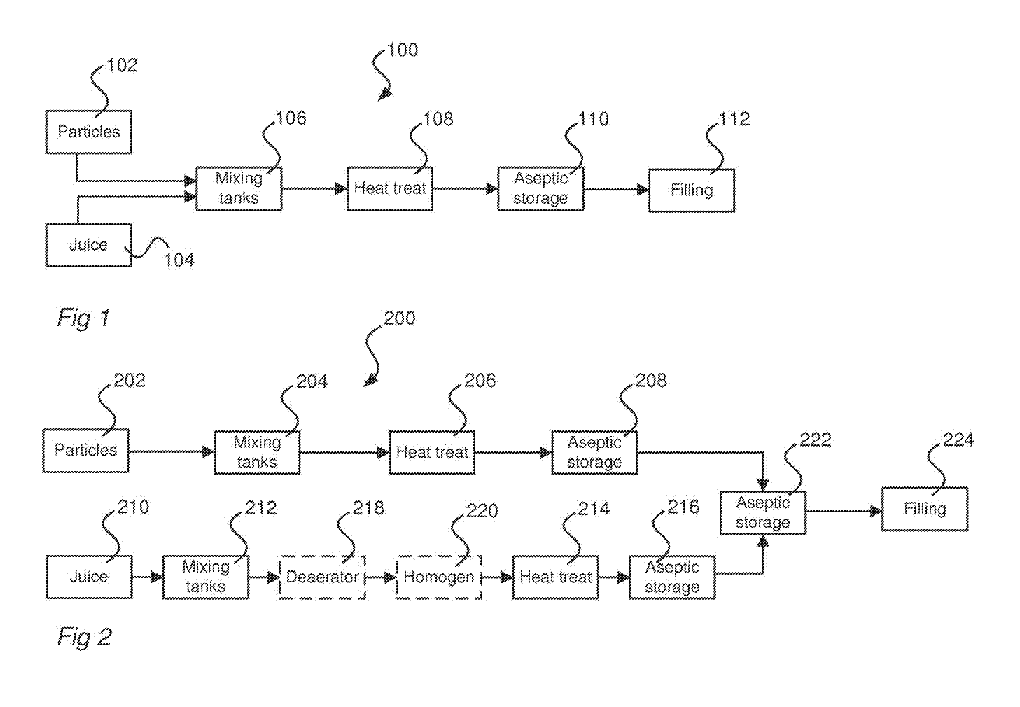

FIG. 1 illustrates an example of the aseptic single line design 100 for processing juice with pulp. In a first step, particles 102, in this example pulp, and juice 104 are mixed in one or several mixing tanks 106. After being mixed, the mixture is transferred to a heat treatment apparatus 108 for heat treating the mixture in order to reduce the number of unwanted microorganisms. Next, after having been heat treated, the mixture is placed in an aseptic storage tank 110 in order to assure that it is not re-contaminated before it is finally transferred to a filling machine 112 and filled in packages or bottles.

One drawback with using this type of line design is that there is a limitation in particle size. Another drawback is that the juice cannot be de-aerated or homogenized when comprising pulp particles.

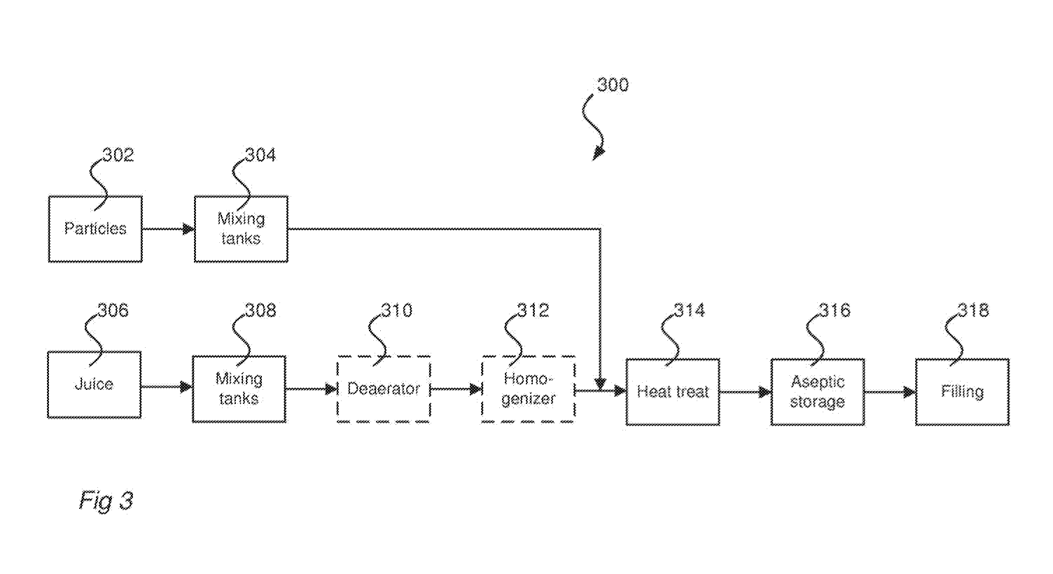

In the aseptic dual line design 200, illustrated in FIG. 2, particles 202 and juice 204 are handled in parallel in the first steps. More particularly, the particles 202 are mixed using mixing tanks 204, thereafter transferred to a heat treatment apparatus 206 for reducing the number of unwanted microorganisms and from there to an aseptic storage tank 208. In a similar way the juice 204 is mixed in mixing tanks 212, heat treated in a heat treatment apparatus 214 and stored in an aseptic storage tank 216.

An advantage of this approach is that there are two sets of equipment making it possible to optimize both for particles and for juice. For instance, the mixing tanks used for mixing the pulp particles may be provided with a different agitator set up compared to the mixing tanks used for the juice. Further, the heat treatment apparatus 206 used for the particles may be a tubular heat exchanger made for handling products with high fiber content, while the heat treatment apparatus 214 used for the juice may be a plate heat exchanger suitable for handling liquid food products without fibers.

By handling the juice and the particles separately, the juice can, if considered necessary to achieve a final food product meeting set expectations, be transferred from the mixing tanks 212 to a de-aerator 218 and further, also if considered necessary, to a homogenizer 220.

After being treated separately the particles in the aseptic storage tank 216 and the juice in the aseptic storage tank 208 are transferred to an aseptic storage tank 222 made to hold the juice and the particles, and from there transferred to a filling machine 224.

With an aseptic dual line the particle integrity is improved compared to an aseptic single line. Further effects of processing the juice and the pulp particles separately are that the juice can be heat treated in an optimal way without taking particles into consideration. This means that a more gentle heat treatment may be used for the juice, in turn having the effect that the product properties, such as taste, can be less affected.

The drawback with the aseptic dual line compared to the aseptic single line is that more equipment is needed, in turn increasing the capital expenditures.

An advantage of an aseptic processing line compared to a non-aseptic line is that the output of the heat treatment apparatuses 206, 214 may be stored at ambient temperature, thereby not requiring any cooling system.

However, equipment made to be used in aseptic lines is generally more expensive than equipment to be used in non-aseptic lines. For instance, the aseptic storage tanks 208, 216, 222 must be closed to make sure that the product is not re-contaminated. Further, after being cleaned, they need to be pre-sterilized, using e.g. hot water or steam, to make sure that the product is not contaminated.

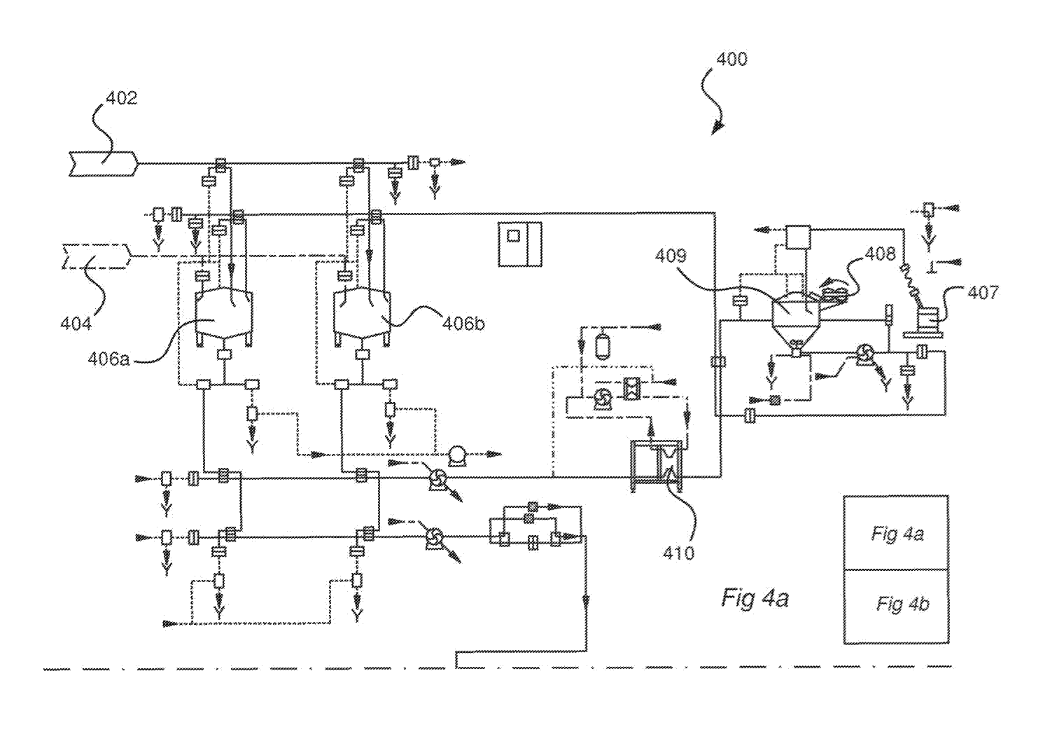

In order to reduce the capital expenditures, but keep the positive effects of handling the particles and the juice separately, it is provided a food processing line 300 illustrated in FIG. 3.

As in the aseptic dual line design, particles 302 are mixed in mixing tanks 304, and in parallel juice 306 is mixed in mixing tanks 308. Optionally, the juice can after being mixed be transferred to a de-aerator 310 for reducing air content and/or to a homogenizer 312 for treating the juice such that desired properties, such as texture, are achieved.

However, unlike the aseptic dual line design illustrated in FIG. 2, the particles are, after being mixed in the mixing tanks 304, transferred together with the juice 306, after being mixed in the mixing tanks 308 and optionally de-aerated and/or homogenized, to a heat treatment apparatus 314. After being heat treated the juice with particles can be sent to an aseptic storage tank 316 and therefrom to a filling machine 318.

Compared to the dual aseptic line illustrated in FIG. 2, the number of heat treatment apparatuses can be reduced as well as the number of aseptic storage tanks.

Although the example refers to juice and particles, the principle applies generally to a liquid or semi-liquid product being a composition of a first sub-composition having a low concentration of particles and a second sub-composition having a high concentration of particles.

Further, although the line design illustrated in FIGS. 1, 2 and 3, all refer to aseptic processing lines, the principles may however also be applied on non-aseptic processing lines, that is, for instance, food processing lines arranged to process food products to be stored in a chilled environment, thereby requiring only a milder heat treatment.

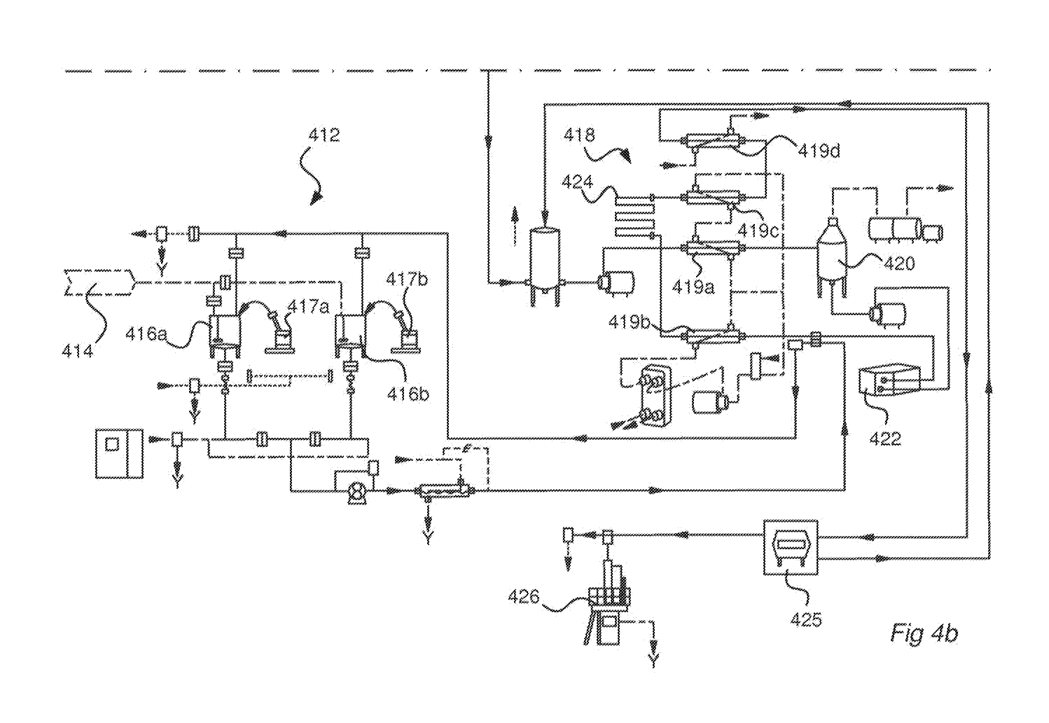

Referring to FIG. 4a and FIG. 4b it is illustrated a schematical flow chart of an example of a food processing line 400 in line with the food processing line illustrated in FIG. 3.

Starting with FIG. 4a, in order to prepare the first sub-composition, in this example juice, a sugar solution 402 is received. The sugar solution 402 has been prepared by dissolving sugar in water according to well known processes.

Water 404 may also be received. The water may be added to the juice in order to achieve the right balance between sugar and water, but may also be used for flushing the system before and after cleaning the processing line or parts thereof.

In this particular example, two mixing tanks 406a, 406b are used for mixing the sugar solution with a juice concentrate mixture. The juice concentrate mixture are formed by mixing juice concentrate 407 and/or powder 408 together with water in a mixer 409, for instance a high shear mixer, such as Tetra Almix marketed by Tetra Pak. One reason for having a mixer 409 for preparing the juice concentrate mixture is that this will provide for a more efficient mixing in the mixing tanks 406a, 406b.

In order to provide for that the mixing of the juice concentrate mixture and the sugar solution is facilitated a heat exchanger 410 may be used for making sure that a temperature of the juice concentrate mixture and the sugar solution is in a temperature interval enabling good mixing.

Now referring to FIG. 4b, in a particle preparation section 412 water 414 is transferred to two mixing tanks 416a, 416b provided with agitators. Particles are added into to the two mixing tanks 416a, 416b via two particles containers 417a, 417b. When having formed a particles mixture, that is, the second sub-composition with a high concentration of particles, also referred to as particles slurry, this is transferred to a heat treatment apparatus 418.

In this example the heat treatment apparatus 418 comprises one or several tubular heat exchanger having four different sections. The first sub-composition formed in the mixing tanks 406a, 406b is sent to a first section 419a of the heat treatment apparatus 418 for being pre-heated. After being pre-heated the first sub-composition is transferred to a deaerator 420 and to a homogenizer 422.

Before entering a second section 419b of the heat treatment apparatus 418 the first sub-composition and the second sub-composition are combined. In the second section 419b the temperature is increased to a temperature the pathogenic microorganisms, and other unwanted microorganisms, can only stand for a short period of time. In order to assure that the temperature is kept longer than this short period of time and thereby that these microorganisms are killed a holding cell 424 can be used.

After being in the holding cell 424 the first and second sub-composition are transferred to a third section 419c for being cooled, and from there to a fourth section 419d in which external cold water is used for cooling further.

After being heat treated, the first and second sub-composition is transformed into the final product and is fed to an aseptic storage tank 425. From the aseptic storage tank the final product is fed to a filling machine 426 for packing the final product in carton packages, bottles or any other suitable container for holding the final product.

As illustrated, the final food product may, as an alternative to being fed to the filling machine 426, be fed back to a balance tank and from there to the heat treatment apparatus 418. The reason for having this possibility is that there is an upper time limit for how long time the final food product can be kept in the aseptic storage tank without being negatively affected, for instance re-contaminated, and therefore in case, for instance, the filling machine 426 stops the final product can be fed back to the heat treatment apparatus 418, instead of being wasted when the upper time limit is reached.

The invention has mainly been described above with reference to a few embodiments. However, as is readily appreciated by a person skilled in the art, other embodiments than the ones disclosed above are equally possible within the scope of the invention, as defined by the appended patent claims.

1. A processing system for processing a liquid or semi-liquid food product, said food product being a composition of a first sub-composition having a low concentration of particles and a second sub-composition having a high concentration of particles, wherein said high concentration is greater than said low concentration, said processing system comprising
a first mixing tank for mixing said first sub-composition,
a second mixing tank for mixing said second sub-composition,
a heat treatment apparatus arranged to receive said first sub-composition and said second sub-composition and to heat treat said first sub-composition and said second sub-composition.

2. The processing system according to claim 1, wherein said heat treatment apparatus is divided in a plurality of sections, wherein a first set of said plurality of sections is arranged to pre-heat said first sub-composition to a pre-heat treatment temperature and a second set of said plurality of sections is arranged to heat treat said first sub-composition and said second sub-composition at a heat treatment temperature, wherein said pre-heat treatment temperature is lower than said heat treatment temperature.

3. The processing system according to claim 1, further comprising
a deaerator arranged to deaerate said first sub-composition.

4. The processing system according to claim 3, wherein said first sub-composition is pre-heated in said heat treatment apparatus before being transferred to said deaerator.

5. The liquid food processing system according claim 1, further comprising
a homogenizer arranged to homogenize said first sub-composition.

6. The processing system according to claim 5, wherein said first sub-composition is pre-heated in said heat treatment apparatus before being transferred to said homogenizer.

7. The liquid food processing system according to claim 1, further comprising
an aseptic storage tank arranged to receive said first sub-composition and said second sub-composition from said heat treatment apparatus.

8. The food processing system according to claim 7, wherein said aseptic storage tank is provided with paddle agitators.

9. The food processing system according to claim 1, wherein said second sub-composition comprises water and particles slurry with a ratio of approximately 1:1.

10. The food processing system according to claim 1, wherein said first sub-composition and said second sub-composition are combined with a ratio of approximately 5:1.

11. The food processing system according to claim 1, wherein said first sub-composition comprises 80-95 per cent of water.

12. The food processing system according to claim 1, wherein said first sub-composition comprises 6-18 per cent of sugar.

13. The food processing system according to claim 1, wherein said second sub-composition comprises particles with a size in a range of 1-10 mm.

14. A method for processing a liquid or semi-liquid food product, said food product being a composition of a first sub-composition having a low concentration of particles and a second sub-composition having a high concentration of particles, wherein said high concentration is greater than said low concentration, said method comprising
mixing said first sub-composition in a first mixing tank,
mixing said second sub-composition in a second mixing tank,
heat treating said first sub-composition and said second sub-composition in a heat treatment apparatus arranged to receive said first sub-composition and said second sub-composition such that a final product is formed.

15. The method according to claim 14, further comprising
pre-heating said first composition to a pre-heat treatment temperature in a first set of a plurality of sections of said heat treatment apparatus,
wherein said step of heat treating said first sub-composition and said second sub-composition is made in a second set of said plurality of sections at a heat treatment temperature,
wherein said pre-heat treatment temperature is lower than said heat treatment temperature.

16. The method according to claim 14, further comprising
transferring said final product to a filling machine at ambient temperature.

17. A liquid food product obtained by the method according to claim 14.

18. A processing system for processing a liquid or semi-liquid food product, the processing system comprising:
a first sub-composition possessing a relatively lower concentration of particles;
a second sub-composition possessing a relatively higher concentration of particles;
the concentration of particles in the second sub-composition being greater than the concentration of particles in the first sub-composition;
a first mixing tank connected to the first sub-composition and into which the first sub-composition is introduced to mix the first sub-composition;
a second mixing tank connected to the second sub-composition and into which the second sub-composition is introduced to mix the second sub-composition;
a heat treatment apparatus positioned downstream of both the first mixing tank and the second mixing tank and connected to both the first mixing tank and the second mixing tank to receive the first sub-composition in the first mixing tank and the second sub-composition in the second mixing tank that are combined to produce the food product that is subjected to heat treatment in the heat treatment apparatus;
an aseptic storage tank downstream of the heat treatment apparatus and connected to the heat treatment apparatus to receive and store the food product that has been subjected to the heat treatment; and
a filling machine downstream of the aseptic storage tank and connected to the aseptic storage tank to receive the food product stored in the aseptic storage tank and to fill packages or bottles with the food product.

19. The processing system according to claim 18, wherein the second sub-composition comprises water and particles slurry with a ratio of approximately 1:1, and wherein the first sub-composition comprises 80-95 per cent of water.

20. The method according to claim 14, wherein the first sub-composition and the second sub-composition are combined with a ratio of approximately 5:1.
